(19) United States
(12) Patent Application Publication
(10) Pub. No.: US 2014/0077643 A1
(43) Pub. Date: Mar. 20, 2014

(54) SPINDLE MOTOR

(71) Applicant: SAMSUNG ELECTRO-MECHANICS CO., LTD., Suwon (KR)

(72) Inventors: Satoru Sodeoka, Suwon (KR); Ju Ho Kim, Suwon (KR); Hyun Ho Shin, Suwon (KR)

(73) Assignee: SAMSUNG ELECTRO-MECHANICS CO., LTD., Suwon (KR)

(21) Appl. No.: 13/688,450

(22) Filed: Nov. 29, 2012

(30) Foreign Application Priority Data
Sep. 14, 2012 (KR) 10-2012-0102151

(51) Int. Cl. H02K 5/00

(52) U.S. Cl. CPC H02K 5/00
USPC 310/90

(57) ABSTRACT

There is provided a spindle motor including: a shaft having a lower end portion fixed to one of a base member and a lower thrust member and provided with an installation groove depressed downwardly from an upper surface thereof; an upper thrust member including an insertion part inserted into and fixed to the installation groove of the shaft; and a rotating part forming a bearing clearance together with the upper and lower thrust members and the shaft and rotating around the shaft.

### CROSS-REFERENCE TO RELATED APPLICATIONS

This application claims the priority of Korean Patent Application No. 10-2012-0102151 filed on Sep. 14, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A small spindle motor used in a hard disk drive (HDD) generally includes a hydrodynamic bearing assembly, and a bearing clearance formed between a shaft and a sleeve of the hydrodynamic bearing assembly is filled with a lubricating fluid such as oil. Fluid dynamic pressure is generated due to compression of oil filling the bearing clearance, thereby rotatably supporting the shaft.

That is, a hydrodynamic bearing assembly generally generates dynamic pressure through spiral shaped grooves in an axial direction and herringbone shaped grooves in a circumferential direction, thereby promoting rotational driving stability in a spindle motor.

Meanwhile, in accordance with the recent increase in capacity of hard disk drives, a technical problem in which vibrations generated during driving of a spindle motor need to be reduced has been generated. That is, in order for a hard disk drive to be driven without errors due to vibrations generated during the driving of a spindle motor, improvements in the performance of a hydrodynamic bearing assembly included in a spindle motor have been demanded.

In addition, in order to improve the performance of a hydrodynamic bearing assembly, there is a need to increase an interval (that is, a bearing span length) between the herringbone shaped grooves to move the center of rotation upwardly, thereby promoting driving stability of a spindle motor.

Meanwhile, in accordance with the recent trend for thinness of hard disk drives, a spindle motor has tended to be miniaturized and thinned. Therefore, thinness may be implemented in a spindle motor by decreasing the interval between the grooves provided in the spindle motor, that is, a length of a dynamic pressure part.

However, when a length of the dynamic pressure part is decreased, as described above, rotational characteristics may be deteriorated. That is, in the case that a bearing span length is decreased, such that rotational characteristics of a rotor may be deteriorated.

Therefore, the development of a structure in which thinness may be implemented in the spindle motor without decreasing the length of the dynamic pressure part, in other words, without decreasing the bearing span length, has been demanded.

### RELATED ART DOCUMENT

(Patent Document 1) Japanese Patent Laid-open Publication No. 2011-12737

### SUMMARY OF THE INVENTION

An aspect of the present invention provides a spindle motor capable of suppressing a deterioration in rotational characteristics thereof, while implementing thinness thereof.

According to an aspect of the present invention, there is provided a spindle motor including: a shaft having a lower end portion fixed to one of a base member and a lower thrust member and provided with an installation groove depressed downwardly from an upper surface thereof; an upper thrust member including an insertion part inserted into and fixed to the installation groove of the shaft; and a rotating part forming a bearing clearance together with the upper and lower thrust members and the shaft and rotating around the shaft.

The upper thrust member may include a disk part having a disk shape, an extension wall part extended from an edge of the disk part, and the insertion part extended from an inner diameter portion of the disk part.

The insertion part may have a thread portion formed in an inner peripheral surface thereof.

The rotating part may include a sleeve forming the bearing clearance together with the upper and lower thrust members and the shaft and a rotor hub extended from the sleeve and having a disk mounted thereon.

The sleeve may be provided with a sealing groove into which the extension wall part is inserted.

The base member may include an installation wall part having a stator core installed on an outer peripheral surface thereof, the installation wall part having an upper surface disposed to be adjacent to a lower surface of the rotor hub.

The spindle motor may further include an upper case forming an internal space together with the base member and having a lower surface closely coupled to an upper surface of the disk part by a screw coupled with the thread portion of the insertion part.

The spindle motor may further include a clamping member installed on an outer peripheral surface of the rotating part in order to allow for a fixation of a disk, wherein the clamping member and the rotating part may be coupled to each other by screw coupling.

According to another aspect of the present invention, there is provided a spindle motor including: a shaft having a lower end portion fixed to one of a base member and a lower thrust member and provided with an installation groove depressed downwardly from an upper surface thereof; an upper thrust member including a disk part having a disk shape, an extension wall part extended from an edge of the disk part, and an insertion part extended from an inner diameter portion of the disk part and insertedly fixed to the installation groove; and a rotating part forming a bearing clearance together with the upper and lower thrust members and the shaft and rotating around the shaft, wherein the insertion part may have a thread portion formed in an inner peripheral surface thereof, and the spindle motor may further include an upper case forming an internal space together with the base member and having a lower surface closely coupled to an upper surface of the disk part by a screw coupled with the thread portion of the insertion part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is a partially cut-away exploded perspective view showing a shaft, upper and lower thrust members, and a rotating part included in the spindle motor according to the embodiment of the present invention; and

FIG. 4 is a bottom perspective view showing the upper thrust member included in the spindle motor according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

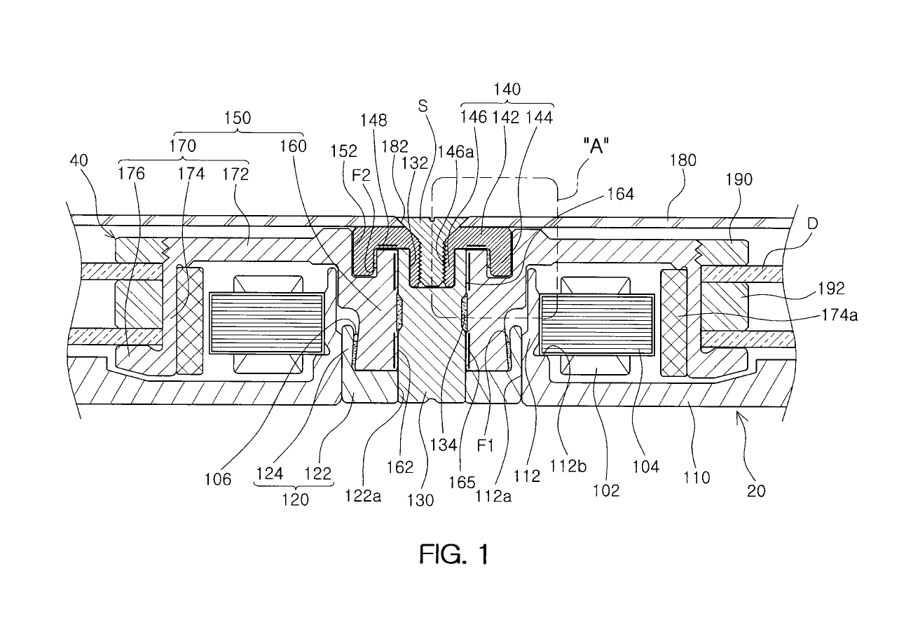

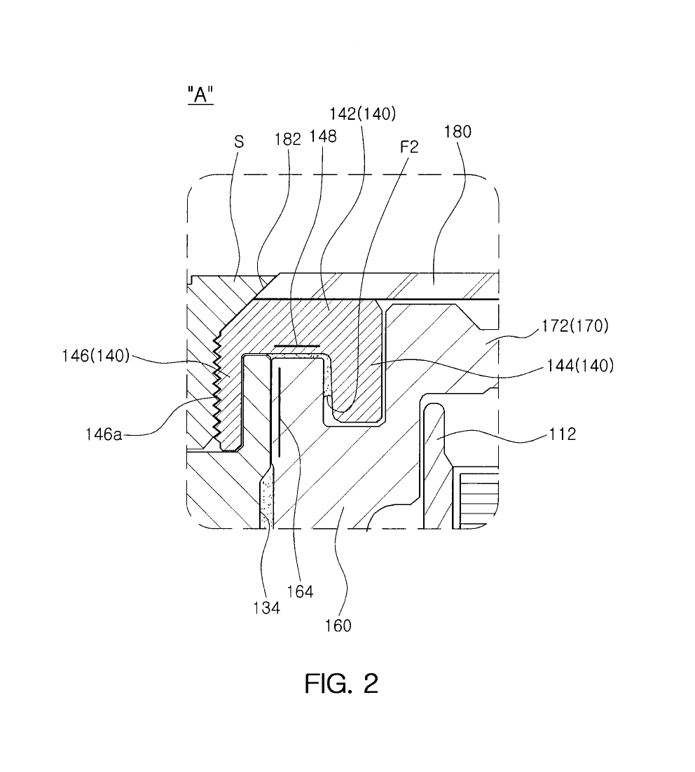

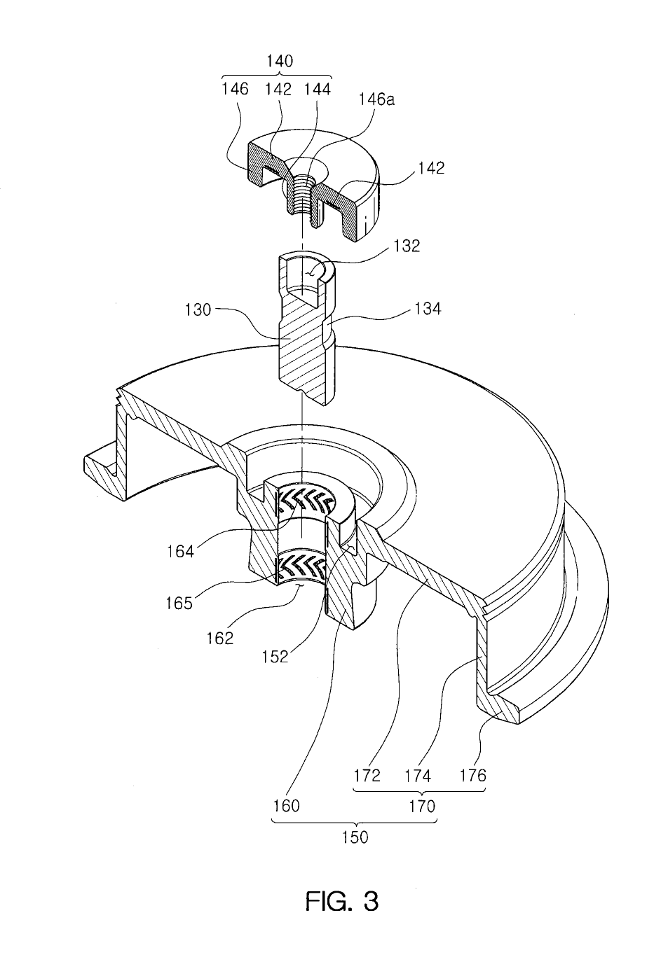

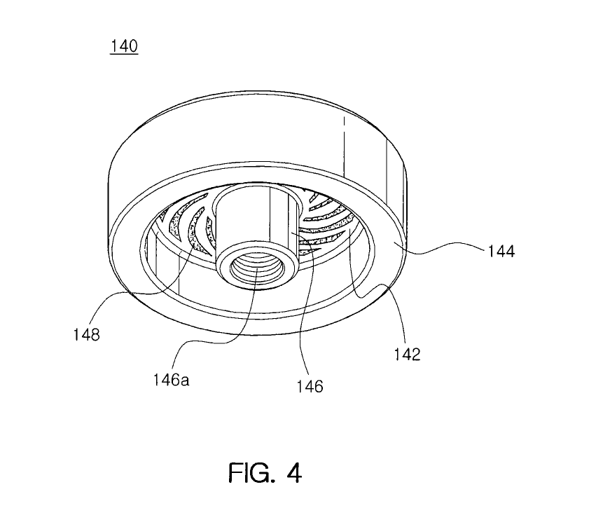

FIG. 1 is a schematic cross-sectional view showing a spindle motor according to an embodiment of the present invention; FIG. 2 is an enlarged view of part A of FIG. 1; FIG. 3 is a partially cut-away exploded perspective view showing a shaft, upper and lower thrust members, and a rotating part included in the spindle motor according to the embodiment of the present invention; and FIG. 4 is a bottom perspective view showing the upper thrust member included in the spindle motor according to the embodiment of the present invention.

Referring to FIGS. 1 through 4, a spindle motor 100 according to the embodiment of the present invention may include a base member 110, a lower thrust member 120, a shaft 130, an upper thrust member 140, a rotating part 150, and an upper case 180 by way of example.

Meanwhile, the spindle motor 100 according to the embodiment of the present invention may be, for example, a motor used in an information recording and reproducing device such as a hard disk drive, or the like.

In addition, the spindle motor 100 according to the embodiment of the present invention may be mainly configured of a stator 20 and a rotor 40.

The stator 20, including all fixed members with the exception of rotating members, may include the base member 110, the lower thrust member 120, the shaft 130, the upper thrust plate 140, and the like.

In addition, the rotor 40 may refer the rotating members rotating together with the shaft 130 and include the rotating part 150, a driving magnet 174a, a clamping member 190, and the like.

Here, terms with respect to directions will be defined. As viewed in FIG. 1, an axial direction refers to a vertical direction, that is, a direction from a lower portion of the shaft 130 toward an upper portion thereof or a direction from the upper portion of the shaft 130 toward the lower portion thereof, and a radial direction refers to a horizontal direction, that is, a direction from the shaft 130 toward an outer peripheral surface of the rotating part 150 or from the outer peripheral surface of the rotating part 150 toward shaft 130.

In addition, a circumferential direction refers to a rotation direction along the outer peripheral direction of the shaft 130 or the rotating part 150.

In addition, the base member 110 may include an installation wall part 112 having the lower thrust member 120 inserted therein. The installation wall part 112 may be protruded upwardly in the axial direction and include an installation hole 112a formed therein to allow the lower thrust member 120 to be inserted therein.

In addition, the installation wall part 112 may include a support surface 112b formed on an outer peripheral surface thereof to allow a stator core 104 having a coil 102 wound therearound to be seated thereon. That is, the stator core 104 may be fixed to the outer peripheral surface of the installation wall part 112 while being seated on the support surface 112b, by an adhesive.

However, the stator core 104 may also be press-fitted in the outer peripheral surface of the installation wall part 112 without using an adhesive. That is, an installation scheme of the stator core 104 is not limited to a scheme of using an adhesive.

In addition, the base member 110 may be manufactured by performing die-casting using aluminum (Al). Alternatively, the base member 110 may also be molded by performing plastic working (for example, press working) on a steel plate.

That is, the base member 110 may be manufactured by various materials and various processing methods, and is not limited to the base member 110 shown in the accompanying drawings.

In addition, an upper surface of the installation wall part 112 may be disposed to be adjacent to a lower surface of the rotating part 150. A detailed description thereof will be provided below.

The lower thrust member 120 and the base member 110, the fixed members, may be included in the stator 20, and may be fixed to the base member 110. That is, the lower thrust member 120 may be inserted in the installation wall part 112. More specifically, the lower thrust member 120 may be installed such that an outer peripheral surface thereof is bonded to an inner peripheral surface of the installation wall part 112.

Further, the lower thrust member 120 may be bonded to the installation wall part 112 by at least one of an adhesion method, a welding method, and a press-fitting method.

Meanwhile, the lower thrust member 120 may include a body part 122 having a disk shape and a sealing wall part 124 extended from an edge of the body part 122 in the axial direction.

That is, the lower thrust member 120 may have a cup shape.

Meanwhile, the body part 122 of the lower thrust member 120 may have an inner surface bonded to the shaft 130. To this end, the body part 122 of the lower thrust member 120 may be provided with a mounting hole 122a to allow the shaft 130 to be mounted therein. That is, a lower end portion of the shaft 130 may be insertedly mounted in the mounting hole 122a.

Further, the lower thrust member 120 may serve as a sealing member for preventing a lubricating fluid from being leaked.

Meanwhile, a lower thrust dynamic pressure groove (not shown) may be formed in at least one of an upper surface of the body part 122 and the lower surface of the rotating part 150 disposed to face the upper surface of the body part 122, to generate thrust fluid dynamic pressure.

Meanwhile, the sealing wall part 124 of the lower thrust member 120 and an outer peripheral surface of a sleeve 160 of the rotating part 150 may form a lower sealing part 106 to form a first liquid-vapor interface F1.

However, although the case in which the lower thrust member 120 is fixed to the base member 110 has been described by way of example in the embodiment, the present invention is not limited thereto. That is, the lower thrust member 120 may be spaced apart from the base member 110 and may be fixed to the shaft 130.

The shaft 130, a fixed member configuring the stator 20 together with the base member 110, may have the lower end portion fixed to the lower thrust member 120. That is, as described above, the lower end portion of the shaft 130 may be inserted into the mounting hole 122a of the lower thrust member 120.

In addition, the lower end portion of the shaft 130 may be bonded to the lower thrust member 120 by at least one of an adhesion method, a welding method, and a press-fitting method.

Although the case in which the shaft 130 is fixed to the lower thrust member 120 has been described by way of example in the embodiment, the present invention is not limited thereto. That is, the shaft 130 may also be fixed to the base member 110.

In addition, the shaft 130 may be provided with an installation groove 132 depressed downwardly from an upper surface thereof. The installation groove 132 may serve to allow a thickness of the upper thrust member 140 to be reduced. A detailed description of the installation groove 132 will be provided at the time of a description of the upper thrust member 140.

The upper thrust member 140, a fixed member configuring, together with the base member 110, the lower thrust member 120, and the shaft 130 described above, the stator 20, may be fixed to an upper end portion of the shaft 130.

Meanwhile, the upper thrust member 140 may have an insertion part 146 inserted into and fixed to the installation groove 132 of the shaft 130. That is, the upper thrust member 140 may include a disk part 142 having a disk shape, an extension wall part 144 extended from an edge of the disk part 142 downwardly in the axial direction, and the insertion part 146 extended from an inner diameter portion of the disk part 142.

As described above, since the upper thrust member 140 includes the extension wall part 144 and the insertion part 146, a predetermined space may be formed between the extension wall part 144 and the insertion part 146. In addition, the shaft 130 and an upper end portion of the sleeve 160 of the rotating part 150 may be insertedly disposed in the space formed between the extension wall part 144 and the insertion part 146.

Meanwhile, in order to fix the upper thrust member 140 to the shaft 130, the insertion part 146 may be insertedly disposed in the installation groove 132 of the shaft 130. In this case, a lower surface and an outer peripheral surface of the insertion part 146 may be bonded to a bottom surface and a sidewall portion of the installation groove 132 by at least one of an adhesion method, a welding method, and a press-fitting method.

As described above, since a contact area between the shaft 130 and the upper thrust member 140 may be increased by the insertion part 146, a thickness of the disk part 142 of the upper thrust member 140 may be decreased.

That is, in order to prevent the upper thrust member 140 and the shaft 130 from being separated from each other, the upper thrust member 140 and the shaft 130 need to have a predetermined contract area or greater, therebetween. Therefore, in the case in which an inner surface of the upper thrust member 140 and an outer peripheral surface of the shaft 130 are bonded to each other, there is a limitation in decreasing the thickness of the upper thrust member 140. However, the contact area between the shaft 130 and the upper thrust member 140 may be increased due to the insertion part 146, whereby the thickness of the disk part 142 of the upper thrust member 140 may be decreased.

As a result, the thickness of the upper thrust member may be decreased due to a decrease in thickness of the disk part 142, whereby the spindle motor 100 may be further thinned.

Meanwhile, the extension wall part 144 of the upper thrust member 140 and the sleeve 160 of the rotating part 150 may form a second liquid-vapor interface F2.

Further, the upper thrust member 140 may also serve as a sealing member for preventing the lubricating fluid from being leaked.

Meanwhile, an outer peripheral surface of the upper thrust member 140 may be disposed to be spaced apart from an inner peripheral surface of a rotor hub 170 by a predetermined interval to form a labyrinth seal. Therefore, an evaporation of lubricating fluid from the second liquid-vapor interface F2 may be suppressed.

In addition, an upper thrust dynamic groove 148 may be formed in at least one of a lower surface of the disk part 142 of the upper thrust member 140 and an upper surface of the sleeve 160 disposed to face the lower surface of the disk part 142 of the upper thrust member 140.

Meanwhile, the insertion part 146 may have a thread portion 146a formed in an inner peripheral surface thereof in order to allow for installation of the upper case 180. When a screw S is coupled with the thread portion 146a as described above, coupling force between the insertion part 146 and the shaft 130 may be further increased. Therefore, the thickness of the disk part 142 may be further decreased. The rotating part 150, which is a rotating member rotating around the shaft 130, may configure the rotor 40. In addition, the rotating part 150 may form a bearing clearance together with the upper and lower thrust members 140 and 120 and the shaft 130 described above.

Further, the rotating part 150 may be provided with a sealing groove 152 into which the extension wall part 144 of the upper thrust member 140 described above is inserted. Further, the second liquid-vapor interface F2 may be formed in a space formed by an inner wall of the sealing groove 152 and an outer peripheral surface of the extension wall part 144, and a labyrinth seal may be formed by an outer wall of the sealing groove 152 and the outer peripheral surface of the extension wall part 144.

Meanwhile, the rotating part 150 may include the sleeve 160 forming the bearing clearance together with the upper and lower thrust members 140 and 120 and the shaft 130, and the rotor hub 170 extended from the sleeve 160 and having a disk D mounted thereon.

First, the sleeve 160 will be described. The sleeve 160 may be provided with a shaft hole 162 in which the shaft 130 is inserted. Meanwhile, in the case in which the shaft 130 is inserted in the shaft hole 162, an inner peripheral surface of the sleeve 160 and the outer peripheral surface of the shaft 130 may be disposed to be spaced apart from each other by a predetermined interval to form a bearing clearance therebetween.

This bearing clearance may be filled with a lubricating fluid.

Meanwhile, upper and lower radial dynamic pressure grooves 164 and 165 may be formed in at least one of the inner peripheral surface of the sleeve 160 and the outer peripheral surface of the shaft 130.

The upper and lower radial dynamic pressure grooves 164 and 165 may be disposed to be spaced apart from each other by a predetermined interval and have an oil storing groove 134 disposed therebetween.

In addition, the upper and lower radial dynamic pressure grooves 164 and 165 may have a herringbone shape. However, the upper and lower radial dynamic pressure grooves 164 and 165 are not limited to having the herringbone shape, but may also have a spiral shape.

Next, a span length will be described. The span length refer to a length between a region in which fluid dynamic pressure formed by the upper radial dynamic pressure groove 164 has a maximum level and a region in which fluid dynamic pressure formed by the lower radial dynamic groove 165 has a maximum level.

Generally, in order to implement thinness, a decrease in the span length is caused, which leads to a deterioration in rotational characteristics. However, since the thickness of the disk part 142 of the upper thrust member 140 may be decreased as described above, the span length may not be decreased.

Therefore, the deterioration in rotational characteristics may be suppressed.

Meanwhile, a lower end portion of the outer peripheral surface of the sleeve 160 may be inclined to form the liquid-vapor interface F1 with the sealing wall part 124 of the lower thrust member 120.

However, although the case in which the lower end portion of the outer peripheral surface of the sleeve 160 is inclined has been described by way of example in the embodiment, the present invention is not limited thereto. That is, the sealing wall part 124 of the lower thrust member 120 may also be inclined.

In addition, an upper end portion of the outer peripheral surface of the sleeve 160 may form a labyrinth seal with the inner peripheral surface of the installation wall part 112 of the base member 110. Therefore, evaporation of the lubricating fluid through the first liquid-vapor interface F1 may be suppressed. To this end, the installation wall part 112 may be extended to the upper end portion of the outer peripheral surface of the sleeve 160.

In other words, the upper surface of the installation wall part 112 may be disposed to be adjacent to a lower surface of the rotor hub 170 in order to form the labyrinth seal.

The rotor hub 170 may include a rotor hub body 172 having a disk shape, a magnet mounting part 174 extended from an edge of the rotor hub body 172 in the axial direction, and a disk mounting part 176 extended from a distal end portion of the magnet mounting part 174 in the radial direction.

Meanwhile, the magnet mounting part 174 may have a driving magnet 174a installed on an inner surface thereof, wherein the driving magnet 174a is disposed to face a front end of the stator core 104 having the coil 102 wound therearound.

Meanwhile, the driving magnet 174a may have an annular ring shape and may be a permanent magnet generating magnetic force having a predetermined strength by alternately magnetizing N and S poles in the circumferential direction.

Here, rotational driving of the rotating part 150 will be schematically described. When power is supplied to the coil 102 wound around the stator core 104, driving force capable of rotating the rotating part 150 may be generated by electromagnetic interaction between the driving magnet 174a and the stator core 104 having the coil 102 wound therearound. Therefore, the rotating part 150 may rotate.

Therefore, the lubricating fluid filled in the bearing clearance may be pumped by the upper and lower radial dynamic pressure grooves 164 and 165 to generate fluid dynamic pressure. The rotating part 150 may be more stably rotate by the fluid dynamic pressure generated as described above.

The upper case 180 may form an internal space with the base member 110, and a lower surface of the upper case 180 disposed in the vicinity of the shaft 130 may be closely coupled to the disk part 142 of the upper thrust member 140 by the screw S coupled with the thread portion 146a of the insertion part 146.

As described above, since the upper thrust member 140 is pressurized by the upper case 180, the upper thrust member 140 and the shaft 130 may be more firmly coupled to each other.

In addition, the upper case 180 may be provided with a screw hole 182 through which the screw S coupled to the thread portion 146a of the insertion part 146 penetrates. The screw hole 182 may be inclined so as to support a head portion of the screw S.

The clamping member 190 may be installed on an outer peripheral surface of the rotating part 150 in order to allow for a fixation of the disk D and be coupled to the rotating part 150 by screw coupling. That is, male and female threads may be formed in inner peripheral surface of the clamping member 190 and the rotor hub 170, respectively, and the clamping member 190 may be installed on the rotating part 150, in other words, the outer peripheral surface of 150 of the rotor hub 170 by screw coupling. Therefore, an increase in the thickness of the spindle motor 100 due to the clamping member 190 may be prevented.

That is, the increase in thickness the spindle motor 100 due to the clamping member 190 may be prevented as compared with the case in which the clamping member 190 is installed on the upper surface of the rotor hub 170.

Meanwhile, although the case in which two disks D are mounted and a spacer 192 is disposed therebetween has been described by way of example in the embodiment, the present invention is not limited thereto. That is, one disk or three disks may also be mounted.

As described above, since the contact area between the shaft 130 and the upper thrust member 140 may be increased by the insertion part 146, the thickness of the disk part 142 of the upper thrust member 140 may be decreased.

That is, in order to prevent the upper thrust member 140 and the shaft 130 from being separated from each other, a predetermined contact area may be secured between the upper thrust member and the shaft 130. Therefore, in the case in which the inner surface of the upper thrust member 140 and the outer peripheral surface of the shaft 130 are bonded to each other, there is a limitation in decreasing the thickness of the upper thrust member 140. However, the contact area between the shaft 130 and the upper thrust member 140 is increased by the insertion part 146, whereby the thickness of the disk part 142 of the upper thrust member 140 may be decreased.

Therefore, the thickness by the disk part 142 of the upper thrust member 140 is decreased, whereby the spindle motor 100 may be further thinned.

In addition, generally, in order to implement the thinness, a decrease in the span length is caused, which leads to a deterioration in rotational characteristics. However, since the thickness of the disk part 142 of the upper thrust member 140 may be decreased as described above, the span length may not be decreased. Therefore, the deterioration in the rotational characteristics may be suppressed.

Meanwhile, although the case in which the upper thrust dynamic pressure groove 148 is formed in at least one of the upper thrust member and a facing surface of the sleeve 160 disposed to face the upper thrust member and the lower thrust dynamic pressure groove is formed in at least one of the lower thrust member and a facing surface of the sleeve 160 disposed to face the lower thrust member has been described by way of example in the embodiment, the present invention is not limited thereto.

That is, only one of the upper and lower thrust dynamic pressure grooves may also be formed.

Asset forth above, according to the embodiments of the present invention, coupling force between the shaft and the upper thrust member is increased by the insertion part of the upper thrust member, whereby the thickness of the upper thrust member can be decreased.

Therefore, a decrease in span length can be prevented, while implementing thinness, whereby a deterioration in rotational characteristics can be suppressed.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a shaft having a lower end portion fixed to one of a base member and a lower thrust member and provided with an installation groove depressed downwardly from an upper surface thereof;
an upper thrust member including an insertion part inserted into and fixed to the installation groove of the shaft; and
a rotating part forming a bearing clearance together with the upper and lower thrust members and the shaft and rotating around the shaft.

2. The spindle motor of claim 1, wherein the upper thrust member includes a disk part having a disk shape, an extension wall part extended from an edge of the disk part, and the insertion part extended from an inner diameter portion of the disk part.

3. The spindle motor of claim 2, wherein the insertion part has a thread portion formed in an inner peripheral surface thereof.

4. The spindle motor of claim 2, wherein the rotating part includes a sleeve forming the bearing clearance together with the upper and lower thrust members and the shaft and a rotor hub extended from the sleeve and having a disk mounted thereon.

5. The spindle motor of claim 4, wherein the sleeve is provided with a sealing groove into which the extension wall part is inserted.

6. The spindle motor of claim 4, wherein the base member includes an installation wall part having a stator core installed on an outer peripheral surface thereof, the installation wall part having an upper surface disposed to be adjacent to a lower surface of the rotor hub.

7. The spindle motor of claim 3, further comprising an upper case forming an internal space together with the base member and having a lower surface closely coupled to an upper surface of the disk part by a screw coupled with the thread portion of the insertion part.

8. The spindle motor of claim 1, further comprising a clamping member installed on an outer peripheral surface of the rotating part in order to allow for a fixation of a disk,
wherein the clamping member and the rotating part are coupled to each other by screw coupling.

9. A spindle motor comprising:
a shaft having a lower end portion fixed to one of a base member and a lower thrust member and provided with an installation groove depressed downwardly from an upper surface thereof;
an upper thrust member including a disk part having a disk shape, an extension wall part extended from an edge of the disk part, and an insertion part extended from an inner diameter portion of the disk part and insertedly fixed to the installation groove; and
a rotating part forming a bearing clearance together with the upper and lower thrust members and the shaft and rotating around the shaft,
wherein the insertion part has a thread portion formed in an inner peripheral surface thereof,
the spindle motor further comprising an upper case forming an internal space together with the base member and having a lower surface closely coupled to an upper surface of the disk part by a screw coupled with the thread portion of the insertion part.

10. The spindle motor of claim 9, further comprising a clamping member installed on an outer peripheral surface of the rotating part in order to allow for a fixation of the disk,
wherein the clamping member and the rotating part are coupled to each other by screw coupling.
